(19) United States
(12) Patent Application Publication
(10) Pub. No.: US 2011/0016935 A1
(43) Pub. Date: Jan. 27, 2011

(54) PUSHBUTTON LOCK

(76) Inventor: Chia-Hung WANG, Chung-Ho City (TW)

Correspondence Address: Muncy, Geissler, Olds & Lowe, PLLC, 4000 Legato Road, Suite 310, FAIRFAX, VA, 22033, US

(21) Appl. No.: 12/786,979

(22) Filed: May 25, 2010

Related U.S. Application Data
(60) Provisional application No. 61/180,888, filed on May 25, 2009.

(51) Int. Cl. E05B 37/16

(52) U.S. Cl. 70/288

(57) ABSTRACT

A pushbutton lock includes a lock core, a panel, and an interference unit. The lock core includes a case with a plurality of apertures, a plurality of button assemblies each movably disposed corresponding to a respective one of the apertures of the case, and a locking unit movably disposed on the case. The panel has a plurality of holes each for partially exposing one of the button assemblies. The interference unit is coupled with the locking bolt. The interference unit can move together with the locking unit to selectively interfere with the button assemblies and restrict the movement of the button assemblies.

This application claims benefit to a US provisional patent application No. 61/180,888, filed on May 25, 2009.

### BACKGROUND OF THE INVENTION

1. Field of the Invention

The present invention generally relates to a lock structure. Particularly, the present invention relates to a pushbutton lock with an interference unit capable of preventing unauthorized users from prying password.

2. Description of the Prior Art

Pushbutton locks, for example as those disclosed in U.S. Pat. No. 5,768,921 and U.S. Pat No. 4,936,894, have been available for many years. The conventional pushbutton lock generally includes a box covered with a panel on which a lock mechanism having a plurality of button assemblies and a locking bolt is disposed. By entering password through the button assemblies and operating the locking bolt, the panel can be lifted from the box and the pushbutton lock is unlocked. The detailed operations of locking and unlocking the conventional pushbutton lock can refer to the above described U.S. patents and will not be elaborated hereinafter.

However, the conventional pushbutton lock has a drawback that the password can be pried by an unauthorized user by operating the locking bolt to drive the checker plate to contact the button assemblies and pushing the button assemblies one by one to sense the touch feeling of each button assembly. In such a prying manner, the password to the conventional pushbutton lock can be readily found.

Therefore, what is needed is a pushbutton lock capable of preventing unauthorized users from prying the password.

### SUMMARY OF THE INVENTION

It is an object of the present invention to provide a pushbutton lock, which includes an interference unit for preventing unauthorized users from prying the password.

It is another object of the present invention to provide a pushbutton lock, which includes a modularized lock core structure capable of incorporating with an interference unit to enhance the convenience of manufacture and maintenance.

The present invention achieves these and other objects by providing a pushbutton lock including a lock core, a panel, and an interference unit. The lock core includes a case with a plurality of apertures, a plurality of button assemblies each movably disposed corresponding to a respective one of the apertures of the case, and a locking bolt movably disposed on the case. The panel has a plurality of holes each for partially exposing one of the button assemblies. The interference unit is disposed between the lock core and the panel and coupled with the locking bolt. The interference unit can move together with the locking blot to selectively interfere with the button assemblies and restrict the movement of the button assemblies. Since the interference unit can interfere with the button assemblies when the locking bolt moves to the unlocked position, the attempt to find the password by pushing the button assemblies one by one to sense the touch feeling of each button assembly can be effectively prevented.

In another embodiment, the case of the lock core includes an accommodation space for accommodating the interference unit thereon. Moreover, the case further includes a stopper protruding over the accommodation space to limit the vertical movement of the interference unit when the interference unit is disposed in the accommodation space. In such a configuration, the interference unit can be incorporated with the lock core as a modularized structure to fit various types of panels.

### BRIEF DESCRIPTION OF THE DRAWINGS

FIGS. 1A and 1B are respectively a perspective view and an exploded view of an embodiment of the pushbutton lock of the present invention;

FIG. 2 is a perspective view of another embodiment of an upper housing of the case of the present invention;

FIGS. 3A and 3B are perspective views of a modularized lock core structure of the present invention in the locked position and the unlocked position, respectively; and

FIGS. 4A and 4B are schematic top views of the modularized lock core structure of the present invention in the locked position and the unlocked position, respectively.

### DETAILED DESCRIPTION OF THE PREFERRED EMBODIMENT

Referring to the accompanying drawings, one embodiment of a pushbutton lock is described.

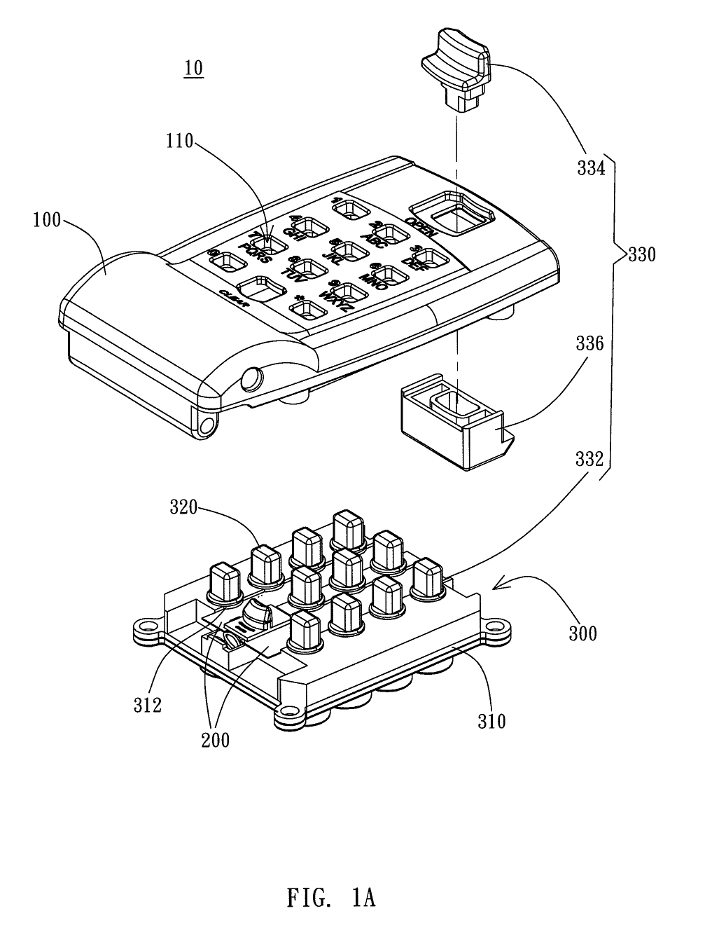

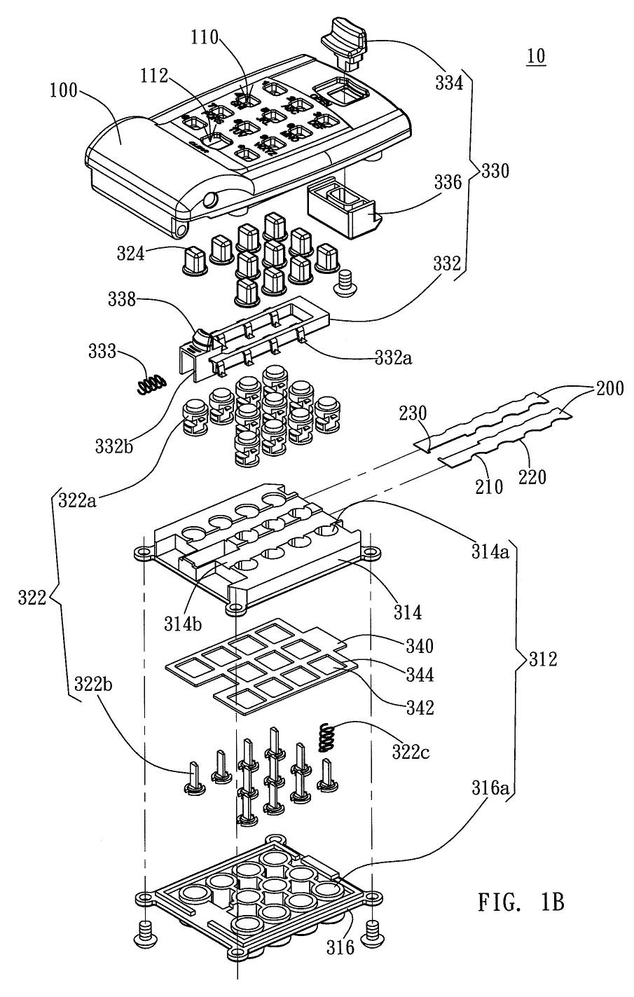

FIG. 1A is a perspective view of an embodiment of the pushbutton lock 10 of the present invention. As shown in FIG. 1A, the pushbutton lock 10 includes a panel 100, an interference unit 200, and a lock core 300. The lock core 300 includes a case 310 with a plurality of apertures 312, a plurality of button assemblies 320, and a locking unit 330. Each button assembly 320 is movably disposed corresponding to a respective one of the apertures 312 of the case 310. The locking unit 330 is movably disposed on the case 310 to be in a locked position and an unlocked position in response to the operation of the user. The panel 100 has a plurality of holes 110, and each hole 110 partially expose one of the button assemblies 320. Therefore, the number of the aperture 312 of the case 310, the number of the hole 110 of the panel 100, and the number of the button assembly 320 are matched. The interference unit 200 is coupled with the locking unit 330 to be movable with the locking unit 330. Therefore, the interference unit 200 is configured to selectively interfere with the button assemblies 320 to restrict movement of the button assemblies 320 as the locking unit 330 is selectively in the locked position and the unlocked position. The structure, relationship, and operation of the panel 100, the interference unit 200, and the lock core 300 will be described in detail hereinafter.

FIG. 1B is an exploded view of the pushbutton lock 10 of FIG. 1A. As shown in FIGS. 1A and 1B, in this embodiment, an upper housing 314 and a lower housing 316 together form the case 310. A plurality of through holes 314a, 316a are correspondingly formed in the upper housing 314 and the lower housing 316. When the upper housing 314 and the lower housing 316 are assembled to serve as the case 310, the corresponding through holes 314a, 316a on the upper and lower housings 314, 316 are integrated into the apertures 312 of the case 310. Furthermore, the lock core 300 also includes a checker plate 340 provided between the upper housing 314 and the lower housing 316. That is, the checker plate 340 is preferably disposed in the space enclosed by the upper housing 314 and the lower housing 316. In one embodiment, the checker plate 340 correspondingly includes a plurality of holes 342 corresponding to the apertures 312 of the case 310 and defines a plurality of edges 344 for engaging with the button assemblies 320. In such a configuration, each button assembly 320 is movably disposed in the respective aperture 312 of the case 310 and partially exposed through the hole 110 of the panel 100 to be operable by the user.

As shown in FIG. 1B, in this embodiment, each button assembly 320 includes a gate unit 322 resiliently and rotatably disposed in the aperture 312 of the case 310 and a cap 324 disposed on the gate unit 322 to be exposed through the hole 110 of the panel 100. In one embodiment, the gate unit 322 includes a control member 322a and an adjustable member 322b. The adjustable member 322b is axially movably connected to the control member 322a and disposed in the lower housing 316 in a manner that the bottom of the adjustable member 322b is exposed through the through hole 316a from the bottom of the lower housing 316 to allow the user to adjust the orientation of the control member 322a for setting the password. The control member 322a are cut two slots or gates, positioned on opposite sides at different positions along its length.

Moreover, a resilient member 322c such as a spring is provided between the control member 322a and the adjustable member 322b to enable the axial movement of the adjustable member 322b with respect to the control member 322a so that the cap 324 can be urged out through the hole 110 of the panel 100. Please note only one exemplary resilient member 322c is illustrated in FIG. 1B as an example. When the user presses the exposed caps 324 of certain button assemblies 320 corresponding to the correct password, the locking unit 330 can be operated to disable the lock 10. That is, by pressing the button assemblies 320 to orient the gates of the control members 322a in a manner that the checker plate 340 can move further enough to be received in the gates of the control member 322a, the locking unit 330 can be in the unlocked position. However, if even one of the control member 322a is not so oriented, the corresponding edge 344 of the checker plate 340 will encounter the button assembly 320 and the locking unit 330 can not move to the unlocked position to disable the lock 10.

As shown in FIGS. 1A and 1B, the locking unit 330 includes a slider 332, a knob 334, and a locking bolt 336. The slider 332 has a plurality of latching parts 332a for engaging with the button assemblies 320. That is, the latching part 332a selectively engages with the control member 322a at different positions along its length to position the button assemblies 320 at a pressed state or an unpressed state. The locking bolt 336 is coupled with the slider 332 and the knob 334. For example, in this embodiment, the locking bolt 336 can be engaged with the knob 334 and the slider 332 to be movable with the knob 334 and to enable the movement of the slider 332. In another embodiment, the locking bolt 336 can be engages with the knob 334 and touch against one end of the slider 332 so as to push the slider 332. The knob 334 is exposed out of the panel 100 to be operable by the user to activate the locked position or the unlocked position of the locking bolt 336. That is when the user presses certain button assemblies 320 corresponding to the correct password, by moving the knob 334, i.e. pushing the knob downwardly, the locking bolt 336 and the slider 332 can be together driven to move toward the unlocked position.

The lock core 300 further includes a reset switch 338, which is disposed on the slider 332 and protrudes perpendicularly through a rest hole 112 of the panel 100. The reset switch 338 can be operated to make the pressed button assemblies 320 return to their original status, i.e. not pressed, when the user intends to clear the wrong password. Moreover, as shown in FIG. 1B, a resilient member 333 such as a spring is provided between the case 310 (e.g. the upper housing 314) and the slider 332. The resilient member 333 provides a restoring force to enable the slider 332 to return to the locked position as appropriate.

Hereinafter, the structure and the operation of the interference unit 200 will be described in detail. As shown in FIGS. 1A and 1 B, the interference unit 200 includes a plurality of releasing parts 210 and a plurality of interference parts 220 alternatively arranged along a lengthwise direction for selectively corresponding to the apertures 312 of the case 310. For example, the interference unit 200 is an interference plate with a plurality of recesses 210 and a plurality of protrusions 220 alternatively arranged along its moving direction for selectively corresponding to the apertures 312 of the case 310. That is, the recesses 210 and the protrusions 220 are arranged one after the other on two sides along its length, which is consistent with the moving direction of the slider 332 of the locking unit 330. Therefore, the interference plate has a concave-convex edge. In this embodiment, the releasing part, i.e. recess 210, preferably has a shape corresponding to the upper rim of the aperture 312, so that when the locking unit 330 is in the locked position, the releasing part 210 corresponds to the aperture 312 and allows the button assembly 320 to travel in the aperture 312. Therefore, the interference unit 200 does not interfere with the button assemblies 320 and the password can be entered when the lock 10 is locked. That is, the cap 324 of the button assembly 320 is allowed to be pushed by the user to orient the gate of the control member 322a. However, in other embodiments, the releasing part, i.e. the recess 210, can have any suitable shape not interfering with the travel of the button assembly 320 in the aperture 312 of the case 310 when the locking unit 330 is in the locked position. Moreover, the interference part, i.e. protrusion 220, of the interference unit 200 is preferably designed in a manner that when the locking unit 330 moves toward the unlocked position, the interference unit 200 moves together with the locking unit 330 so that the releasing part 210 (e.g. recess 210) is shifted from the aperture 312 and the interference part 220 (e.g. protrusion 220) moves to restrict the movement of the button assembly 220.

In this embodiment, two interference plates 200 are disposed on the case 310, i.e. the upper housing 314, and coupled with the locking unit 330. In this embodiment, the interference unit 200 further includes a hook portion 230 which corresponds to the edge 332b of the slider 332. That is, the hook portion 230 of the interference unit 200 is coupled with the edge 332b of the slider 332 so that the interference unit 200 is movable with the slider 332.

Moreover, since the interference unit 200 is disposed on the upper housing 314 of the case 310, the upper housing 314 preferably includes an accommodation space 314b for accommodating the interference unit 200. As shown in FIG. 1 B, the accommodation space 314b can be a groove recessed from the surface of the upper housing 314, so that the lateral movement along the width direction of the interference unit 200 can be limited. That is, the lateral movement of the interference unit 200 is perpendicular to the sliding direction of the slider 332.

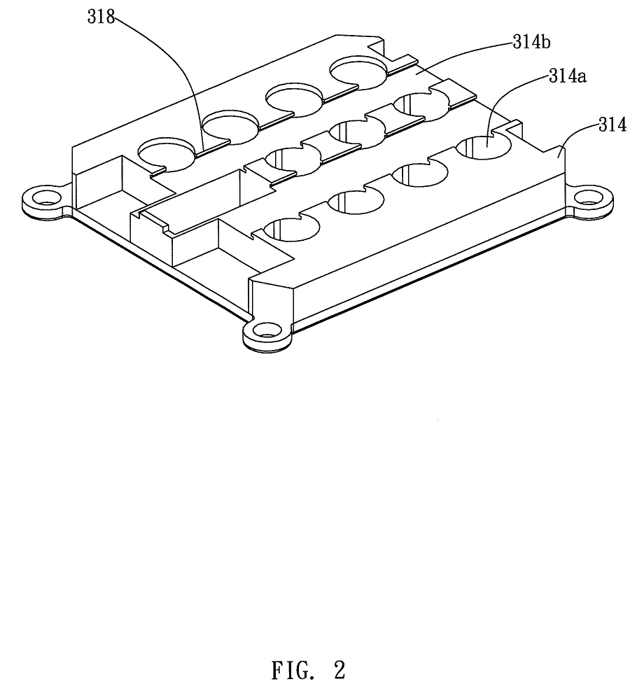

Alternatively or additionally, in order to enhance the stability of the arrangement of the interference unit 200 on the case 310, a stopper can be provided on the case 310 to limit the vertical movement of the interference unit 200. That is, the vertical movement of the interference unit 200 is perpendicular to the lateral movement of the interference unit 200 and the sliding direction of the slider 332. For example, as shown in FIG. 2, in this embodiment, a stopper 318 is provided on the upper housing 314 adjacent to the accommodation space 314b. In one embodiment, the stopper 318 preferably protrudes over the accommodation space 314b to partially cover the interference unit 200. As such, the vertical movement of the interference unit 200 is effectively limited by the stopper 318, and the stability of the interference unit 200 can be enhanced.

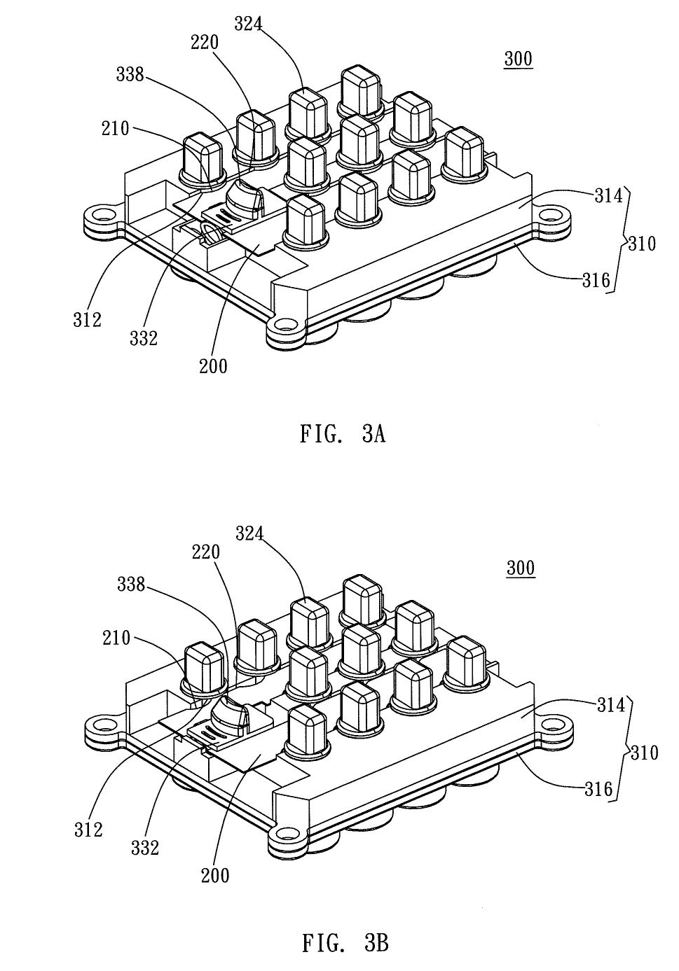

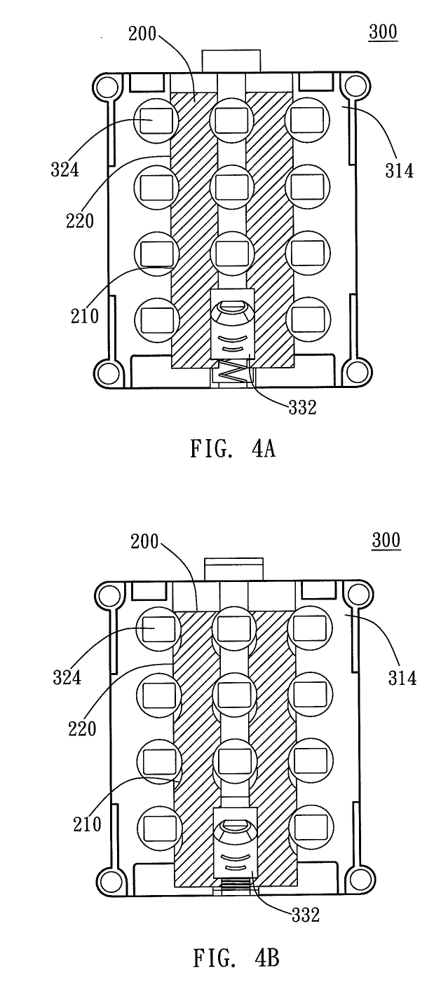

FIGS. 3A and 3B are respectively perspective views of a modularized lock core structure of the present invention in the locked position and the unlocked position, and FIGS. 4A and 4B are respectively schematic top views of the modularized lock core structure of the present invention in the locked position and the unlocked position. The operation of the interference unit 200 and the locking unit 330 will be described in detail with reference FIGS. 3A-4B.

Referring to FIG. 3A and 4A, when the pushbutton lock 10 or the locking bolt 336 is in the locked position, the interference unit 200 is disposed on the upper housing 314 in a manner not to interfere with the travel of the button assemblies 320 in the apertures 312 of the case 310. That is, the releasing parts 210 (e.g. recesses) correspond to the apertures 312 so that the interference unit 200 does not hinder the downward movement of the cap 324. In such a configuration, the user can enter the password by pressing corresponding caps 324 of the button assemblies 320 to orient the gates of the control member 322a and then operating the knob 334 to drive the locking bolt 336 together with the slider 332 to the unlocked position. At the same time, the interference unit 200 engaged with the slider 332 is also moved to displace the releasing parts (e.g. recesses) 210 and the interference parts (e.g. protrusions) 220 so that the interference parts 220 of the interference unit 200 are located between the case 310 and the button assembly 320. That is, when the slider 332 moves to the unlocked position, the interference unit 200 moves together with the slider 332 to interpose the interference parts (e.g. protrusions) 220 between the upper housing 314 and the bottom of the cap 324. In such a configuration, since the correct password has been entered, the movement of the interference unit 200 will not affect the unlock operation.

However, if the correct password has not been entered before operating the locking unit 330, the interference unit 200 can block the button assemblies 320 and prevent unauthorized people from attempting to find the password by sensing the touch feeling. As shown in FIG. 3B and 4B, when the unauthorized user tries to find the password by operating the knob 334 to drive the locking bolt 336 together with the slider 332 toward the unlocked position, the interference unit 200 engaged with the slider 332 is moved to displace the releasing parts 210 and the interference parts 220 so that the interference parts 220 of the interference unit 200 are positioned under the cap 324 or partially cover the apertures 312 so that the movement of the button assemblies 320 are blocked. In such a configuration, the button assemblies 320 can not be pressed downward and accordingly, the attempt to find the password by pushing the button assemblies 320 one by one to sense the touch feeling of each button assembly 320 can be effectively prevented.

Moreover, since the interference unit 200 moves in response with the operation of the lock core 300, the interference unit 200 and the lock core 300 can be integrated as a modularized lock core structure. The modularized lock core structure can be applied to various types of panels to enhance the manufacturability and convenience of maintenance.

In the above embodiments, the interference unit 200 is illustrated as the interference plate having the recesses 210 or the protrusions 220 in the same shape, but is not limited thereto. In other embodiments, the recess or the protrusion of the interference unit can have different shapes as appropriate. Moreover, though two discrete interference plates are illustrated to serve as the interference unit 200 in the above embodiment, the two discrete interference plates may be integrated into a single piece to achieve the same effect. Furthermore, the recesses 210 and the protrusions 220 are arranged one after the other along one side edge of each interference plate 200 in the above embodiment. However, in other embodiments, the recesses 210 and the protrusions 220 can be alternatively arranged on two sides along the lengthwise direction.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A pushbutton lock, comprising:
a lock core including a case with a plurality of apertures, a plurality of button assemblies each movably disposed corresponding to a respective one of the apertures of the case, and a locking unit movably disposed on the case;
a panel having a plurality of holes each for partially exposing one of the button assemblies; and
an interference unit, coupled with the locking unit, for selectively interfering with the button assemblies to restrict the movement of the button assemblies.

2. The pushbutton lock of claim 1, wherein the interference unit is an interference plate with a plurality of recesses and a plurality of protrusions alternatively arranged along a lengthwise direction for selectively corresponding to the apertures of the case.

3. The pushbutton lock of claim 2, wherein the interference plate further includes a hook portion for engaging with the locking unit.

4. The pushbutton lock of claim 2, wherein each button assembly includes a gate unit resiliently and rotatably disposed in the aperture of the case and a cap disposed on the gate unit to be exposed through the hole of the panel.

5. The pushbutton lock of claim 4, wherein the protrusion of the interference plate is interposed between the cap and the casing to block the movement of the cap when the locking unit moves toward an unlocked position.

6. The pushbutton lock of claim 4, wherein the recesses of the interference plate correspond to the apertures of the case to allow the caps to move in the apertures when the locking unit is in a locked position.

7. The pushbutton lock of claim 1, wherein the lock core further includes a checker plate defining a plurality of edges for engaging with the button assemblies.

8. The pushbutton lock of claim 1, wherein the locking unit includes a slider having a plurality of latching parts for engaging with the button assemblies, a knob protruding out of the panel, and a locking bolt coupled with the slider and driven by the knob.

9. The pushbutton lock of claim 8, wherein the panel further includes a reset hole, the slider includes a reset switch protruding through the reset hole.

10. The pushbutton lock of claim 1, wherein the case includes an accommodation space for accommodating the interference unit thereon.

11. The pushbutton lock of claim 10, wherein the case further includes a stopper adjacent to the accommodation space for limiting the movement of the interference unit.

12. A pushbutton lock, comprising:
a case with a plurality of apertures;
a plurality of button assemblies each movably disposed corresponding to a respective one of the apertures of the case;
a slider having a plurality of latching parts for engaging with the button assemblies; and
an interference unit engaged with the slider to move together with the slider, the interference unit having a plurality of interference parts and a plurality of releasing parts alternatively arranged along a lengthwise direction,
wherein the releasing parts correspond to the apertures of the case to allow the button assemblies to travel in the apertures when the slider is in a locked position, and when the slider moves toward an unlock position, the interference unit moves together with the slider so that the releasing parts are shifted from the apertures and the interference parts are moved to restrict the movement of the button assemblies.

13. The pushbutton lock of claim 12, wherein the interference unit further includes a hook portion for engaging with an edge of the slider.

14. The pushbutton lock of claim 12, wherein each button assembly includes a gate unit resiliently and rotatably disposed in the aperture of the case and a cap disposed on the gate unit to be exposed through the hole of the panel.

15. The pushbutton lock of claim 14, wherein when the slider moves toward the unlocked position, the interference part of the interference unit move to be interposed between the cap and the case to block the movement of the cap.

16. The pushbutton lock of claim 12, wherein the lock core further includes a checker plate defining a plurality of edges for engaging with the button assemblies.

17. The pushbutton lock of claim 12, wherein the panel further includes a reset hole, the slider includes a reset switch protruding through the reset hole.

18. The pushbutton lock of claim 12, wherein the case includes an accommodation space for accommodating the interference unit thereon.

19. The pushbutton lock of claim 18, wherein the case further includes a stopper protruding over the accommodation space to limit the movement of the interference unit.
